(19) United States
(12) Patent Application Publication
(10) Pub. No.: US 2002/0055359 A1
(43) Pub. Date: May 9, 2002

(54) Device and method for transfer of data packets

(76) Inventors: Anders Andersson, Kungalv (SE); Peter Bleckert, Goteborg (SE); Gunnar Rydnell, Ravlanda (SE); Kjell Westerberg, Partille (SE)

Correspondence Address: NIXON & VANDERHYE P.C., 8th Floor, 1100 North Glebe Road, Arlington, VA, 22201-4714, US

(21) Appl. No.: 09/986,328

(22) Filed: Nov. 8, 2001

Related U.S. Application Data
(60) Provisional application No. 60/246,716, filed on Nov. 9, 2000.

(51) Int. Cl. H04Q 7/20

(52) U.S. Cl. 455/426; 455/452

(57) ABSTRACT

The invention relates to a transceiver device (1) adapted for transfer of data packets to and from a mobile terminal (4), said transceiver device (1) comprising measuring means for measuring a value corresponding to the quality of said transfer, which is used to make decisions concerning said transfer. Said transceiver device (1) and said mobile terminal (4) include rate changing means for changing the transfer rate of said data packet transfer depending on said decision. The invention also relates to a method for transfer of data packets between a first (1) and a second transceiver (4), said method comprising measuring, in said first transceiver (1), a value corresponding to the quality of said transfer. The method comprises comparing, in said first transceiver (1), said measured value with a predetermined threshold value, and adapting the transmission rate of said transmission depending on whether said measured value exceeds said threshold value.

### TECHNICAL FIELD

The present invention relates to a transceiver device, a mobile terminal and a method, respectively, for mobile communication, according to the preamble of the appended claims 1, 10 respective claim 17.

### BACKGROUND ART

Due to the health hazards concerning microwave radiation, the FCC rules for handheld devices, for example mobile terminals, such as mobile phones limits its power emissions to 2W. These rules may be further restricted if new rules will be adopted. The base station output power, however, is not restricted as strongly, as its radiating elements are not positioned in the vicinity of any human.

There may be systems, e.g. the Mobitex system, configured such that the link budgets, i.e. the calculated losses withdrawn from the input power, on the uplink and downlink are highly unbalanced. Here, the term uplink refers to transmissions from the mobile terminal to the base station, and the term downlink refers to transmissions from the base station to the mobile terminal. The downlink may be up to 6 dB stronger than the uplink. In such a configuration there may be a border area at the edge of the cell, where the mobile terminal can hear the base station but has too low output power on the uplink in order to transmit a message to the network. This situation can result in a limited coverage and a misuse of the transmission capability. The resulting scenario can be that the mobile terminal wastes bandwidth by accessing the system and trying to transmit. Due to the unbalanced link budget, the message will not get through to the base, and bandwidth will be wasted on access collisions and re-transmissions. Also capacity of the downlink can be wasted if control messages, e.g. ACKs (ACKnowledgement, ACK is a Mobitex radio frame), can not be sent from the mobile. On the other hand, there may be a major part of the cell area where the downlink signal to noise ratio is higher than what is required to provide a reliable transmission. In these areas it is wasted transmit power capacity to use full power. The transmitted power then only creates more interference.

In most modern, wireless, packet data communication systems some sort of adaptation algorithm is included. Some systems are based on a fixed TDMA (Time Division Multiple Access) frame structure with distributed adaptation, such that the sender decides on the rate to use and the receiver gives a proposed rate. The fixed frame structure uses equal time slots of a predetermined, fixed size. The fixed TDMA frame structure means that complicated data block structure and/or re-segmentation is required when adapting on retransmissions. Most systems are symmetric on up- and downlink, such that an estimate of e.g. the downlink gives an indication on the quality of the uplink and vice versa. Such symmetry between the channels gives an easier implementation of an adaptation algorithm than in a system where there is no correspondence of the channels.

When a message is not received properly, and an REB (Repetition Request) is issued, known systems retransmit the packet in the same manner as last time, hoping for better conditions that time.

### DISCLOSURE OF INVENTION

The object of the invention is to provide devices and respective method that solve the above-mentioned problem of a system with asymmetric channels.

This object is accomplished by means of a transceiver device of a kind mentioned in the preamble, with characterising features as disclosed in the appended claim 1, where the transceiver device is adapted for transfer of data packets and comprising measuring means for measuring a value which corresponds to the quality of said transfer. The measured value is then used to make decisions concerning said transfer. The transceiver device is characterized in that it includes rate changing means for changing the transfer rate of said data packet transfer depending on said decision.

The object is also accomplished by means of a mobile terminal of a kind mentioned in the preamble, with characterising features as disclosed in the appended claim 10, which is adapted for transfer of data packets to and from a transceiver device which comprises equipment for measuring a value which corresponds to the quality of said transfer, which measured value is used to make decisions concerning said transfer. The mobile terminal is characterized in that it is adapted for changing the transfer rate of said data packet transfer depending on said decision.

The object is also accomplished by means of a method of a kind mentioned in the preamble, which characterising features are disclosed in the appended claim 17, which method discloses transfer of data packets between a first transceiver, and a second transceiver, said method comprising measuring, in said first transceiver, a value corresponding to the quality of said transfer. The invention is characterized in that it comprises comparing, in said first transceiver, said measured value with a predetermined threshold value, and adapting the transmission rate of said transmission depending on whether said measured value exceeds said threshold value.

Preferable embodiments of the invention are disclosed in the appended dependent claims.

### BRIEF DESCRIPTION OF DRAWINGS

The invention will be described below in connection with an example of a preferred embodiment and the enclosed drawings, where

FIG. 1 shows a simplified drawing of a mobile station and a user carrying a mobile terminal, such as a mobile phone;

FIG. 2 shows a simplified drawing of a cellular grid, typical for mobile communication systems;

FIG. 3 shows a principal sketch of the data packets for uplink communication;

FIG. 4 shows a principal sketch of the data packets for downlink communication;

FIG. 5 shows a flow chart for uplink communication; and

FIG. 6 shows a flow chart for downlink communication.

### MODES FOR CARRYING OUT THE INVENTION

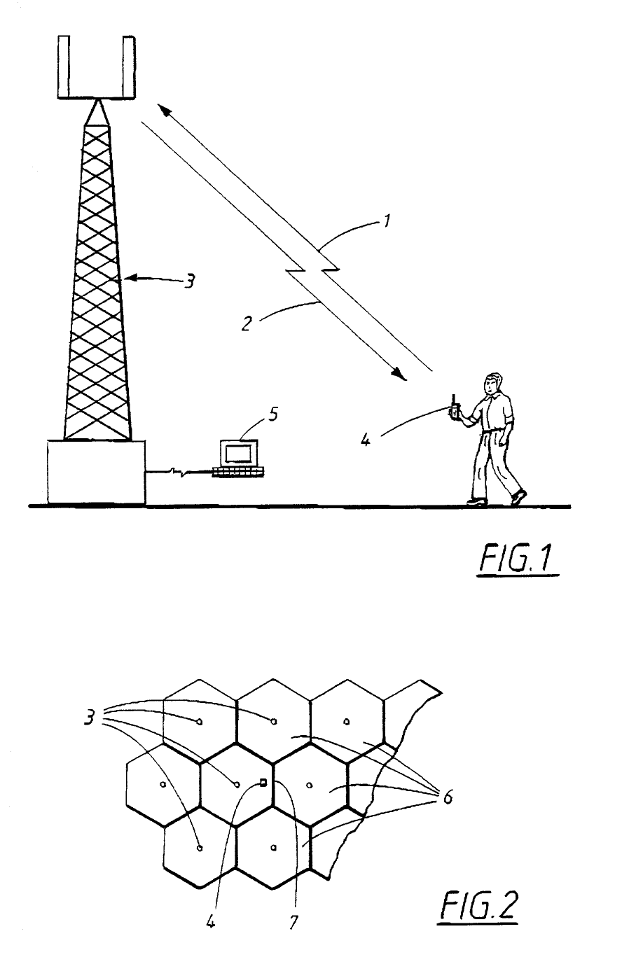

This invention constitutes an improvement in the field of asymmetric wireless packet data networks. One such network is the so-called Mobitex network. With reference to FIGS. 1 and 2, the invention is applicable to the Mobitex network which is used in the further discussion as an example for illustration of the features, but the use of the invention is not restricted to the Mobitex network, but applicable to any asymmetric wireless packet data network, i.e. a wireless network where the uplink 1 and downlink 2 link budget is unbalanced in such a way that, for example, downlink transmissions are possible, but not uplink transmissions. This may be due to the different output powers for the uplink and downlink transmitters. This may be the case for any asymmetric mobile telephone (cellular phone) system or a mobile data system.

The Mobitex network consists of interconnected cells, each of which is served by a radio base station 3 that provides wireless access to the network for mobile users. The base stations 1 and other network nodes are connected together by fixed links. Despite these basic similarities, Mobitex is unique in several key respects. The characteristics that define the technology and make Mobitex unique in today's market are that it is a narrowband data-only network and that it provides packet data services to users carrying handheld devices, such as mobile terminals 4 (MS).

Mobitex is a data-only network. This means that it was designed from the start to carry data traffic, and that data transfers cannot be blocked by voice calls. Services provided to the user normally include 2-way text messaging. Also, web based data service may be provided, particularly suitable is a WAP (Wireless Application Protocol) based service. The invention is, however, not limited to data-only networks, but is also applicable for voice and audio networks. The service is based on high reliability, such that all messages can be end-to-end acknowledged. The radio channel in the Mobitex system provides an 8 kb/s radio link that is shared by the users. The Mobitex system provides radio coverage over most populated parts of the US, and also in other countries.

Unlike circuit-switched voice networks in which a dedicated connection must be established and maintained for the duration of the call, a packet-switched network breaks the data stream up into small packets, each of which can be sent across the network individually. No dedicated connections are needed, and network access is virtually instantaneous, because each data packet contains the destination address and can be routed dynamically as network conditions change, in order for the end user 5 to receive the data packet.

The network is planned in a cellular fashion, see FIG. 2, where a mobile terminal 4 such as a mobile phone (cellular phone) measures signal strength from base stations 1 and chooses to register to the closest or the strongest one. When the mobile terminal 4 moves into the coverage area of a new base station 3 and the new base station 3 provides a stronger RSSI-value (Receiver Signal Strength Information), the mobile terminal 4 sends a registering packet to the new base station 3 to register. All packets will then be routed via the new registered base station 3.

According to the prior art, the Mobitex radio link provides 8 kb/s data rate on both uplink 1 and downlink 2 to all users in a radio cell 6 on both the uplink 1 and the downlink 2. However, the sensitivity on the up- 1 and downlinks 3 may not be symmetric. Due to FCC rules for handheld devices, the power emission from a mobile terminal 4 is restricted to 2 W, and may be further restricted if new rules will be adopted. The base station's 1 power emission is not restricted as strongly. There may be systems configured such that the link budgets are highly unbalanced.

The downlink 2 may be up to 6 dB stronger than the uplink 1. In such a configuration there may be a border area at the edge 7 of the cell 6, where the mobile terminal 4 can hear the base station 3, but has too low output power on the uplink 1 to transmit a message to the network. This situation can result in a limited coverage and a misuse of the transmission capability. The resulting scenario can be that the mobile terminal 4 wastes bandwidth by accessing the system and trying to transmit. Due to the unbalanced link budget, the message will not get through to the base station 3, and bandwidth will be wasted on access collisions and re-transmissions. Also capacity of the downlink 2 can be wasted if control messages, e.g. ACKs (ACKnowledgement, ACK is a Mobitex radio frame), can not be sent from the mobile terminal 4.

On the other hand, there may be a major part of the cell 6 area where the downlink signal to noise ratio is higher than what is required to provide a reliable transmission. In these areas it is wasted transmit power capacity to use full power. The transmitted power then only creates more interference.

A new method, according to this invention, is designed to adapt the data rate on the radio channel according to said radio channel's link budget conditions for each mobile terminal 4. The method is called ADR (Adaptive Data Rate). The method consists of two parts, an uplink 1 rate adaptation and a downlink 2 rate adaptation. In this example, the uplink 1 adaptation method will be called LDR (Low Data Rate) which for this specific embodiment example corresponds to 25% of default data rate, and the downlink 2 adaptation method will be called HDR (High Data Rate) which for this specific embodiment example corresponds to 600% of default data rate. It should be understood that these data rates only are stated as examples, and may be altered within the scope of the invention. Due to the asymmetric character of the up- 1 and downlink 2 channels, it is only the network side that has direct knowledge of the relation between up- 1 and downlink 2.

The base station 3 may transmit with a high power on the downlink 2 and the mobile terminal can not make any assumptions about the received signal strength from the base station 3 from measuring the downlink 2. According to the embodiment, the adaptation algorithm will be placed in the base station 3. This also allows for flexible software updates of the procedure. The mobile terminal 4 measures the RSSI value on the downlink 2 and reports to the base station 3 in measurement reports. Based on mobile terminal reports, the base station adaptation algorithm makes an estimate of the channel and decides on what data rate to use when transmitting to the mobile terminal 4 on the downlink 2.

For the uplink data rate adaptation, the base station algorithm makes a decision based on RSSI measurement in the base station 3 on transmissions from the mobile terminal 4. The decided uplink data rate is indicated to the mobile terminal 4 in a message sent back to the mobile terminal 4. The mobile terminal 4 then has to continue its transmission using the data rate that the base station 3 has decided upon. At any time it is possible for the base station adaptation algorithm to change the chosen rate and indicate this to the mobile terminal 4. In this way retransmitted blocks can be sent using a lower data rate if so required.

Due to the fact that the link does not have a fixed time frame structure, it is possible to extend a transmission in time when doing a retransmission of a data block using a lower data rate. This means that it is possible to keep protocol message definitions and that data block sizes do not have to be changed depending on the transmission rate to fit into any fixed time slots. Also, due to the independent nature of the up- and downlink adaptation algorithms, a situation may occur, where only one of the links is adapted, or even the situation where the adaptation is such that the uplink 1 is in low rate while the downlink 2 is in high rate. The detailed description of the algorithm is given below.

According to the new method for adapting data rate to the radio environment conditions described in this invention, the following procedures are executed in the Mobitex system for uplink 1 and downlink 2 transmissions:

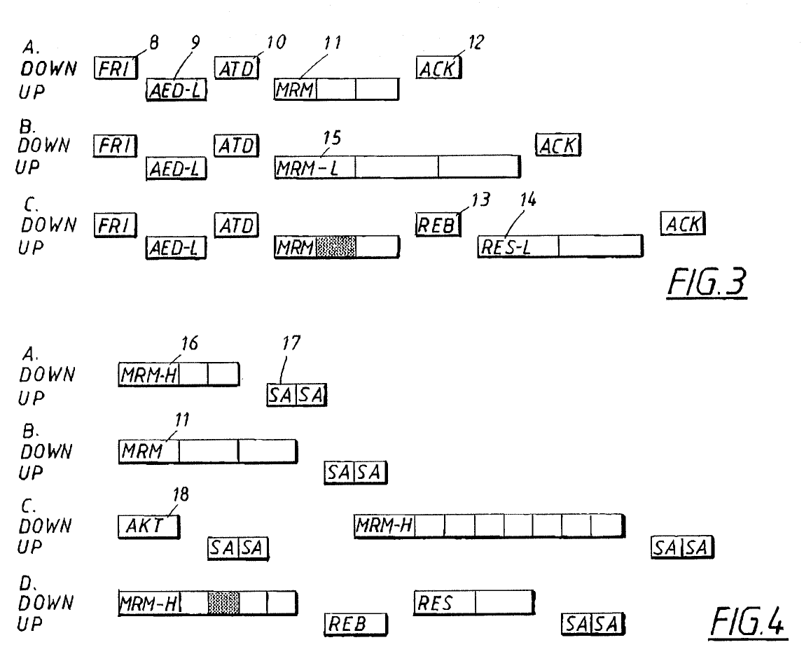

A general uplink 1 transmission procedure will be described in the following with reference to FIG. 3. The specific events in FIG. 3 will be described in detail following the general procedure below.

1. A mobile terminal (MS) has registered on a radio packet data channel served by a base station. It has already performed a successful registering procedure and registered in the current base station. The mobile terminal monitors the system channel in order to receive packet notations. The mobile terminal also makes RSSI measurements of own and neighbor cells in order for making registering decisions.

2. When the mobile terminal 4 has a data packet to transmit to the network, it must wait for a FRI 8 (Free, FRI is a Mobitex radio frame) signal indicating the following access time slots, The base station 3 allocates an appropriate number of access timeslots at appropriate intervals according to the traffic situation. All of these access time slots can be used by both new LDR mobile terminals 4 and old ones. The base station 3 will be able to detect both types of mobile terminals 4 by doing parallel detection of the ABD (Access Request Data, ABD is a Mobitex radio frame) messages in LDR and in normal mode. This is accomplished by parallel detection of the message synch pattern, which indicates which mode that is used in the rest of the message.

3. The mobile terminal shall send an ABD message in an access slot and require uplink 1 transmission resources for the data packet. The data packet consists of a number of blocks up to a maximum size. A mobile terminal 4 using LDR always sends the ABD on the lower data rate; ABD-L 9. The ABD-L 9 shall include the latest measured RSSI-value for the current base station 3.

4. When the base station 3 receives an ABD-L 9, it checks the RSSI-value measured during the reception of the ABD-L 9. Using the two available RSSI-values (for uplink 1 and downlink 2) the base station 3 decides which data rate to use for the following data transfer. The normal operation for a base station 3 is to have a threshold value for the RSSI-value measured during the ABD-L 9. If the measured value exceeds the threshold the default data rate should be used, otherwise the lower data rate should be used.

5. The base station 3 schedules the mobile terminal 4 for transmission of the packet on the uplink 1 and sends an ATD 10 (Access Granted Data, ATD is a Mobitex radio frame) message to the mobile terminal 4, indicating to the mobile terminal 4 that it will get exclusive access to the channel and can start transmission. The ATD 10 includes information about which data rate to use for the transmission of the data packet, the MRM 11 (Message frame, MRM is a Mobitex radio frame), which only contains the message itself, e.g. an e-mail.

6. The mobile terminal transmits the MRM 11 using the decided data rate.

7. The base station sends an ACK 12 (Acknowledgement, ACK is a Mobitex radio frame), NACK (Negative Acknowledgement, NACK is a Mobitex radio frame) or REB 13 (Repetition Request, REB is a Mobitex radio frame) indicating reception status and optionally requesting retransmission of erroneous blocks in the MRM 11. The re-transmission is sent in a RES (Repetition Answer, RES is a Mobitex radio frame) message. The REB 13 includes information about which data rate to use for the re-transmission. It should be noted that a RES could be transmitted using a lower data rate than the corresponding MRM, then designated RES-L 14. A radio block includes the same amount of user data regardless of the used data rate.

The scenarios in FIG. 3 are either one of the following, with reference letters A, B and C:

A. The base station 3 sends FRI 8, and the mobile terminal 4, capable of LDR, sends ABD-L 9. The base station 3 responds with ATD 10. The mobile terminal 4 sends MRM 11 using default data rate since RSSI during ABD-L 9 exceeds a predetermined threshold.

B. The base station 3 sends FRI 8, and the mobile terminal 4, capable of LDR, sends ABD-L 9. The base station 3 responds with ATD 10. The mobile terminal 4 sends MRM 11 using LDR, i.e. MRM-L 15, since RSSI during ABD-L 9 falls below a predetermined threshold.

C. The base station 3 sends FRI 8, and the mobile terminal 4, capable of LDR, sends ABD-L 9, The base station 3 responds with ATD 10. The mobile terminal 4 sends MRM 11 using default data rate, but the base station 3 does not receive the MRM 11 properly, why the base station 3 sends a REB 13. The mobile terminal then sends a RES using LDR, i.e. RES-L 14.

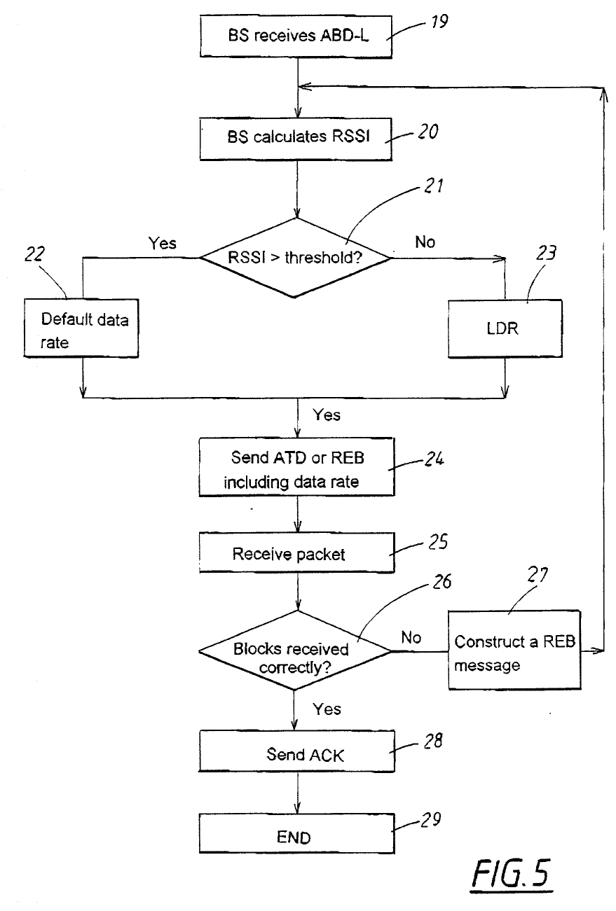

A general downlink transmission procedure will be described in the following with reference to FIG. 4. The specific events in FIG. 4 will be described in detail following the general procedure below.

1. A mobile terminal 4 (MS) has registered on a radio packet data channel served by a base station 3. It has already performed a successful registering procedure and registered in the current base station 3. The mobile terminal 4 monitors the system channel in order to receive packet notations. The mobile terminal 4 also makes RSSI measurements of own and neighbor cells 6 in order for making registering decisions.

2. When the base station 3 has a data packet to transmit to a mobile terminal 4, the base station 3 makes a choice of the data rate to use on the downlink 2. The base station 3 needs to know if the mobile terminal 4 is capable of HDR or not. This information has to be included in the subscriber information.

3. If the mobile terminal 4 is not capable of HDR, the packet is transmitted to the mobile terminal 4 in the usual way.

4. If the mobile terminal 4 is capable of HDR, the adaptation algorithm in the base station 3 needs to make a decision based on available information about the mobile terminal's 4 reception status, RSSI or other information. See FIG. 4 and the following discussion of the possible ways for the adaptation algorithm to choose the correct data rate.

5. The base station 3 transmits the data packet, the MRM 11, to the mobile terminal 4. In all MRM 11 using HDR (MRM-H 16) the primary block is transmitted without using HDR. In this primary block it is stated that the following blocks are transmitted using HDR. The advantage is that the same sync can be used as in default data rate and the vital primary block has a high probability to be received correctly. Alternatively, a flag in the sync shall be used to indicate HDR frames.

6. RSSI-measurements shall be performed during receptions of all MRM 11 by the mobile terminal 4. The result shall be included in the response of the MRM 11 (ACK 12, REB 13 or NACK).

7. If the RSSI level indicated by the mobile terminal 4 in the ACK 12 exceeds a defined threshold the base station shall use HDR for the next downlink packet.

Downlink 2 transmission scenarios will be described in the following.

To be able to exploit the HDR possibility, a timer has to be used in the base station. This timer (HDT) shall indicate if it still is suitable to use HDR for a downlink packet. The timer shall be set when a packet is sent using HDR. When a downlink 2 packet shall be sent to the mobile terminal 4 and the HDT has not expired, HDR shall be used and the HDT shall be restarted. The timer period is preferably, but not exclusively, about 10 seconds. This means that if the timer has not expired when a new message is about to be sent, the same data rate is used as last time, as the possibility of a change of the radio environment conditions then is considered to be low.

When a downlink packet shall be set and the mobile is capable of HDR there are four cases, shown in FIG. 4 below, with reference letters A, B, C and D:

A. The HDT is set and has not expired. The packet is sent using HDR, the packet is then labeled MRM-H 16, and acknowledged with SA 17 (Short Acknowledge, SA is a Mobitex radio frame).

B. No active HDT and a short packet. The packet is sent not using HDR, just an ordinary MRM 11, and acknowledged with SA 17.

C. No active HDT and a long packet. An AKT 18 (Activity Request, AKT is a Mobitex radio frame) is sent from the base station 3. The mobile terminal 4 includes the measured RSSI value in the SA 17. If the SA 17 includes a good enough RSSI, the HDT is set and the packet is sent using HDR, and acknowledged with SA 17 as shown in FIG. 4. Else the default rate is used.

D. The HDT is set and has not expired, why the packet is sent from the base station 3 using HDR. Normally, if the mobile terminal's 4 response of an MRM-H 16 is a REB 13, the RES is sent from the base station 3 using default data rate and acknowledged with SA 17, as shown in FIG. 4.

The limit between short and long packet has to be defined (only important for implementation in the base station).

The short ACK (SA 17 in FIG. 4) could be replaced with ACK-L using normal LDR coding or the same coding as the ABD-L.

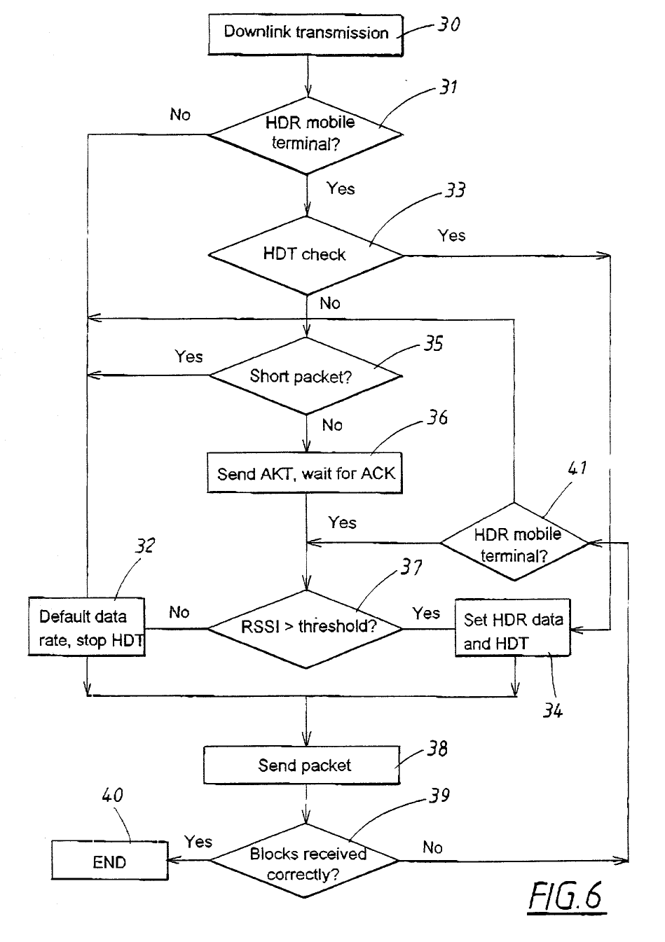

The up- 1 and downlink 2 procedures are also described in the flowcharts disclosed in FIG. 5 and FIG. 6 respectively. As shown in FIG. 5, there is a flowchart describing the uplink 1:

19: First the base station schedules FRI slots and receives an ABD-L from a LDR capable mobile terminal 4.

20: The base station 3 calculates a weighted RSSI value from the RSSI measured on the received message and the RSSI reported by the mobile (in the ABD or any other message).

21: The base station checks if the weighted RSSI exceeds a predetermined threshold. If the weighted RSSI exceeds a predetermined threshold,

22: default data rate is chosen for mobile transmission

or, if the weighted RSSI falls below a predetermined threshold,

23: LDR is chosen for mobile transmission.

24: Send indication (ATD or REB) to the mobile including information about which data rate to use for the transmission of the data packet (MRM or RES).

25: Receive the packet from the mobile in the chosen mode.

26: Are all blocks received correctly? If not, then

27: construct a REB message to transmit ARQ (Automatic Repeat Request) feedback to the mobile,

or, if all blocks are received correctly, then

28: send ACK, followed by

29: END.

As shown in FIG. 6, we have a flowchart describing the downlink 2:

30: The base station 3 has a data packet to transmit to a mobile terminal 4.

31: The base station checks the subscriber information to see if the mobile terminal 4 is capable of HDR. If not,

32: choose default data rate, and stop HDT. Then continue as described at reference number 38.

Or else, if the mobile terminal 4 is capable of HDR,

33: the base station checks if the timer HDT is set and has not expired. If that is the case,

34: choose HDR data rate, and set HDT. Then continue as described at reference number 38.

Or else, if the timer HDT is not set and has expired,

35: determine if the packet is a short packet (shorter than a predefined threshold). If yes, continue as described at reference number 32. If the answer is no,

36: send AKT using default data rate and wait for ACK.

37: Then the base station 3 checks if the RSSI indicated in the response (ACK or REB) exceeds a predetermined threshold. If yes, continue as described at reference number 34. If no, continue as described at reference number 32.

38: Send the packet using the chosen mode and wait for ACK or REB.

39: Then check if all blocks are received correctly as indicated by ACK or REB. If yes, then

40: END.

If no,

41: then the base station 3 checks the subscriber information to see if the mobile terminal 4 is capable of HDR. If yes, continue as described at reference number 37. If no, continue as described at reference number 32.

In one embodiment of the present invention, more error-correcting codes are used when the data transmission rate is decreased. In the example described above this is the case when the data packet is sent from the mobile terminal 4 to the base station 3, i.e. the uplink 1, using LDR.

In one other embodiment of the present invention, the wireless packet data network is combined with a wire-bound network.

In the examples above, the data rate from the mobile terminal 4 to the base station 3 is default or low, and the data rate from the base station 3 to the mobile terminal 4 is default or high. The invention is not limited to these embodiments, but the data rate from the mobile terminal 4 to the base station 3 may be low, high or default. In the same manner, the data rate from the base station 3 to the mobile terminal 4 may be low, high or default.

Not only the data rates low, high and default may be used, but more levels for the data rate may be used in the invention.

The invention is not limited to what has been described above, but may be varied freely within the scope of the appended claims.

1. Transceiver device (1) adapted for transfer of data packets and comprising measuring means for measuring a value which corresponds to the quality of said transfer, which measured value is used to make decisions concerning said transfer, characterized in that said transceiver device (1) includes rate changing means for changing the transfer rate of said data packet transfer depending on said decision.

2. Transceiver device (1) according to claim 1, characterized in that the transceiver device (1) comprises a decision means for the decision made at the transceiver device (1), which is carried out as a comparison between said measured value and a predetermined threshold value.

3. Transceiver device (1) according to claim 1, characterized in that the transceiver device (1) is used in a mobile phone system (cellular phone system) or a mobile data system.

4. Transceiver device (1) according to claim 1, characterized in that the transceiver device (1) is used for the Mobitex system.

5. Transceiver device (1) according to claim 1, characterized in that the transceiver device (1) comprises selecting means for selecting one of the three data transmission rates low, default or high.

6. Transceiver device (1) according to claim 5, characterized in that low data transmission rate corresponds to 25% of default data transmission rate, and that high data transmission rate corresponds to 600% of default data transmission rate.

7. Transceiver device (1) according to claim 1, characterized in that a timer is used at the transceiver device (1), said timer indicating whether it is still suitable to use a data transmission rate separate from the default data transmission rate, i.e. if the timer has not expired when a new message is about to be sent, the same data transmission rate is used as last time.

8. Transceiver device (1) according to claim 1, characterized in that a wireless packet data network is combined with a wire-bound network.

9. Transceiver device (1) according to claim 1, characterized in that the transceiver device (1) is a base station (1).

10. Mobile terminal (4) adapted for transfer of data packets to and from a transceiver device (1) which comprises equipment for measuring a value which corresponds to the quality of said transfer, which measured value is used to make decisions concerning said transfer, characterized in that said mobile terminal (4) is adapted for changing the transfer rate of said data packet transfer depending on said decision.

11. Mobile terminal (4) according to claim 10, characterized in that the mobile terminal (4) is used in a mobile phone system (cellular phone system) or a mobile data system.

12. Mobile terminal (4) according to claim 10, characterized in that the mobile terminal (4) is used for the Mobitex system.

13. Mobile terminal (4) according to claim 10, characterized in that the Mobile terminal (4) comprises selecting means for selecting one of the three data transmission rates low, default or high.

14. Mobile terminal (4) according to claim 13, characterized in that low data transmission rate corresponds to 25% of default data transmission rate, and that high data transmission rate corresponds to 600% of default data transmission rate.

15. Mobile terminal (4) according to claim 10, characterized in that a wireless packet data network is combined with a wire-bound network.

16. Mobile terminal (4) according to claim 1, characterized in that the mobile terminal (4) is a mobile phone (cellular phone).

17. Method for transfer of data packets between a first transceiver (1), and a second transceiver (4), said method comprising:
measuring, in said first transceiver (1), a value corresponding to the quality of said transfer
characterized in that it comprises
comparing, in said first transceiver (1), said measured value with a predetermined threshold value, and
adapting the transmission rate of said transmission depending on whether said measured value exceeds said threshold value.

18. Method according to claim 17, characterized in that the method is used in a mobile phone system (cellular phone system) or a mobile data system.

19. Method according to claim 17, characterized in that the method is used for the Mobitex system.

20. Method according to claim 17, characterized in that it comprises means for selecting one of the three data transmission rates low, default or high.

21. Method according to claim 20, characterized in that low data transmission rate corresponds to 25% of default data transmission rate, and that high data transmission rate corresponds to 600% of default data transmission rate.

22. Method according to claim 17, characterized in that it comprises increasing the amount of error-correcting codes when the data transmission rate is decreased.

23. Method according to claim 17, characterized in that it comprises extending a transmission in time when doing a retransmission of a data block that has been considered as erroneous using a lower data rate.

24. Method according to claim 17, characterized in that it comprises including information whether the second transceiver (4) is capable of data transmission rates separate from the default data transmission rate in the subscriber information.

25. Method according to claim 17, characterized in that it comprises stating in the first data block which data transmission rate that is used for the following data blocks for all transmissions from the first transceiver (1) to the second transceiver (4).

26. Method according to claim 17, characterized in that it comprises performing measurements of transfer quality at the first transceiver (1) during all receptions from the second transceiver (4).

27. Method according to claim 17, characterized in that it comprises using a timer at the first transceiver, said timer indicating whether it is still suitable to use a data transmission rate separate from the default data transmission rate, i.e. if the timer has not expired when a new message is about to be sent, the same data transmission rate is used as last time.
